(19) United States
(12) Patent Application Publication
(10) Pub. No.: US 2016/0137543 A1
(43) Pub. Date: May 19, 2016

(54) APPARATUS AND METHOD FOR PROCESSING LENGTHS OF FLEXIBLE GLASS

(71) Applicant: Coming Incorporated, Corming, NY (US)

(72) Inventors: Anatoli Anatolyevich Abramov, Painted Post, NY (US); Robertson Dewhurst Booth, Elmira, NY (US); Marvin William Kemmerer, Odessa, NY (US)

(21) Appl. No.: 14/778,471

(22) PCT Filed: Mar. 17, 2014
(86) PCT No.: PCT/US14/30119

§ 371 Date: Sep. 18, 2015

Related U.S. Application Data
(60) Provisional application No. 61/803,610, filed on Mar. 20, 2013.

(51) Int. Cl. C03B 33/023; C03B 33/033; B26F 3/00; C03B 33/03

(52) U.S. Cl. CPC C03B 33/0235; C03B 33/03; C03B 33/033; B26F 3/002

(57) ABSTRACT

Apparatuses and methods are described for separating glass sheets from lengths of flexible glass. According to one embodiment, a glass processing apparatus comprises a vent forming device configured to provide a partial or full vent in a surface of a length of flexible glass along an intended line of separation, a break table comprising a first portion and a second portion, the first second portions of the break table configured to rotate with respect to each other along a hinging line, and a glass securing device configured to secure the length of flexible glass to the first and second portions of the break table for separating the length of flexible glass into multiple lengths of flexible glass along the intended line of separation.

This application claims the benefit of priority under 35 U.S.C. §119 of U.S. Provisional Application Ser. No. 61/803,610 filed on Mar. 20, 2013, the content of which is relied upon and incorporated herein by reference in its entirety.

### FIELD

This disclosure generally relates to apparatuses and methods for processing lengths of flexible glass.

### BACKGROUND

Glass manufacturing apparatus are commonly used to form various glass products such as LCD sheet glass. Glass substrates in flexible electronic applications are becoming thinner and lighter. Glass substrates having thicknesses lower than 0.5 mm, such as less than 0.3 mm, such as 0.1 mm or even thinner can be desirable for certain display applications, especially portable electronic devices such as laptop computers, handheld devices and the like. It is known to manufacture glass ribbon by downwardly flowing molten glass over a forming wedge and using edge rollers to engage beads formed at opposite edge portions of a glass ribbon. Once formed, the glass ribbon may be further processed, for example, by cutting the glass ribbon into lengths or spooling the glass.

### SUMMARY

Embodiments disclosed herein include apparatuses and methods for processing lengths of flexible glass. The flexible glass disclosed herein can be processed with glass handling and glass processing apparatuses. As a non-limiting example, the flexible glass can be separated by using a break table as part of a glass processing apparatus.

According to a first aspect, a glass processing apparatus comprises a vent forming device configured to provide a partial or full vent in a surface of a length of flexible glass along an intended line of separation, a break table comprising a first portion and a second portion, the first or second portions of the break table configured to rotate with respect to each other along a hinging line, and a glass securing device configured to secure the length of flexible glass to the first and second portions of the break table for separating the length of flexible glass into multiple lengths of flexible glass along the intended line of separation.

According to a second aspect, there is provided the glass processing apparatus of aspect 1, wherein the vent forming device is a laser cutting device.

According to a third aspect, there is provided the glass processing apparatus of aspect 1,wherein the vent forming device is a mechanical vent forming device.

According to a fourth aspect, there is provided the glass processing apparatus of any one of aspects 1-3, wherein the break table includes an air bearing assembly configured for positioning the flexible glass on the break table.

According to a fifth aspect, there is provided the glass processing apparatus of any one of aspects 1-4, wherein the glass securing device includes a first nosing arm for securing the length of flexible glass to the first portion of the break table and a second nosing arm for securing the length of flexible glass to the second portion of the break table.

According to a sixth aspect, there is provided the glass processing apparatus of aspect 5, wherein the first nosing arm is spaced from the second nosing arm, the hinging line located between the first and second nosing arms.

According to a seventh aspect, there is provided the glass processing apparatus of any one of aspect 5 or aspect 6, wherein the vent forming device moves between the first nosing and the second nosing to provide the partial or full vent in the surface of the length of flexible glass along the intended line of separation. Typically, laser cutting of glass having a thickness of ≦250 microns will lead to a full vent or separation of the glass without the need to flex or bend the glass to place a portion thereof in tension.

According to an eighth aspect, there is provided the glass processing apparatus of any one of aspects 5-7, wherein the break table comprises a vacuum assembly to hold the flexible glass during formation of the partial or full vent.

According to a ninth aspect, there is provided the glass processing apparatus of any one of aspects 1-8, wherein the break table comprises an actuation mechanism for controlling movement of one or more of the first portion and the second portion of the break table.

According to a tenth aspect, there is provided the glass processing apparatus of any one of aspects 1-9, wherein the partial or full vent extends across a portion of the entire width of the flexible glass.

According to an eleventh aspect, there is provided a method of splicing a length of glass comprises feeding an initial length of flexible glass to a break table, securing the initial length of flexible glass to the break table, creating a partial or full vent on a surface of the initial length of flexible glass along an intended line of separation using a vent forming device, rotating a first portion of the break table with respect to a second portion of the break table along a hinging line, and separating the initial length of flexible glass along the intended line of separation upon rotating the first portion of the break table with respect to the second portion of the break table into a first length of flexible glass and a second length of flexible glass. For glass thickness of less than 250 microns, laser cutting typically results in a full separation so the vent (or median crack) propagates through the thickness of the glass in one step. Accordingly, a separate breaking step is not required with this type of cutting. However, the break table rotation is still useful even with this type of cutting, as it will allow the separated parts to be moved away from one another while avoiding edge rubbing, whereby high edge strength can be maintained.

According to a twelfth aspect, there is provided the method of aspect 11 further comprising joining the first length of flexible glass with a leader web.

According to a thirteenth aspect, there is provided the method of aspect 11 or aspect 12 further comprising spooling the first length of flexible glass with the leader web joined thereto into a spool of glass.

According to an fourteenth aspect, there is provided the method of any one of aspects 11-13 further comprising securing the initial length of flexible glass to the break table by a vacuum assembly.

According to a fifteenth aspect, there is provided the method of any one of aspects 11-14 further comprising securing the initial length of flexible glass to the break table by a first nosing arm located at the first portion of the break table and a second nosing arm located at the second portion of the break table.

According to a sixteenth aspect, there is provided the method of any one of aspects 11-15 further comprising securing the initial length of glass to the break table using a nosing arm having a nosing material that comprises rubber.

According to a seventeenth aspect, there is provided the method of any one of aspects 11-16 further comprising feeding the initial length of flexible glass along a conveyance path using a gantry of vacuum heads.

According to an eighteenth aspect, there is provided the method of any one of aspects 11-17, wherein the vent is a partial vent that extends through less than the entire thickness of the flexible glass.

According to a nineteenth aspect, there is provided the method of any one of aspects 11-18, wherein the partial or full vent extends across a portion of the entire width of the flexible glass.

According to a twentieth aspect, there is provided a method of separating lengths of flexible glass comprises feeding a length of flexible glass to a break table, positioning the length of flexible glass on the break table, applying a force to the length of flexible glass to secure the length of flexible glass to the break table, and scoring the length of flexible glass to form a partial or full vent along an intended line of separation using a vent forming device. The method also provides for rotating a first portion of the break table with respect to a second portion of the break table about a hinging line using an actuation mechanism, propagating the partial or full vent through the thickness along the length of flexible glass, and separating the length of flexible glass into two portions.

According to a twenty-first aspect, there is provided the method of aspect 20 further comprising applying a force to the length of flexible glass to secure the length of flexible glass to the break table by a vacuum assembly.

According to an twenty-second aspect, there is provided the method of any one of aspects 20 or 21 further comprising applying a force to the length of flexible glass to secure the length of flexible glass to the break table by a first nosing arm located at the first portion of the break table and a second nosing arm located at the second portion of the break table.

According to a twenty-third aspect, there is provided the method of any one of aspects 20-22, wherein the first nosing arm is spaced from the second nosing arm, the hinging line located between the first and second nosing arms.

According to a twenty-fourth aspect, there is provided the method of any one of aspects 20-23, wherein the step of scoring the length of flexible glass to form the partial or full vent includes positioning a vent forming device between the first nosing and the second nosing.

Additional features and advantages of the embodiments described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIGS. 1-2 are schematic drawings of a glass handling apparatus and “U” shaped loops;

FIG. 3 illustrates one embodiment of a break table with multiple nosings;

FIG. 4 illustrates the break table of FIG. 3 with a defect initiation assembly;

FIGS. 5-7 schematically depict the break table and defect initiation assembly of FIG. 4 along with a separated length of flexible glass;

FIG. 8 illustrates an upper surface with a vacuum assembly of the break table shown in FIG. 3;

FIGS. 9-12 illustrate another embodiment of the break table and multiple nosings of FIG. 1 oriented vertically with a length of flexible glass; and

FIG. 13 illustrates a length of flexible glass positioned over the break table of FIGS. 9-12 spliced to a leader web.

### DETAILED DESCRIPTION

Embodiments disclosed herein generally relate to apparatuses and methods for processing lengths of flexible glass, such as spooling or unspooling lengths of flexible glass, separating lengths of flexible glass from each other, and splicing lengths of flexible glass together, for example, for spooling. The apparatuses and methods described herein may be used together and separately. For example, a glass handling apparatus may be used to collect and deliver lengths of flexible glass to a downstream process. A glass processing apparatus may be used to separate and/or join the lengths of flexible glass received from the spooling and unspooling apparatus or elsewhere.

The flexible glass described herein may have a thickness of 0.3 mm or less including but not limited to thicknesses of, for example, about 0.01-0.05 mm, about 0.05-0.1 mm, about 0.1-0.15 mm, about 0.15-0.3 mm, including 0.3, 0.275, 0.25, 0.225, 0.2, 0.19, 0.18, 0.17, 0.16, 0.15, 0.14, 0.13, 0.12, 0.11, 0.10, 0.09, 0.08 0.07, 0.06, 0.05, 0.04, 0.03, 0.02, or 0.01 mm. The flexible glass may be formed of glass, a glass ceramic, a ceramic material or composites thereof. A fusion process (e.g., downdraw process) that forms high quality flexible glass sheets can be used in a variety of devices such as flat panel displays. Glass sheets produced in a fusion process may have surfaces with superior flatness and smoothness when compared to glass sheets produced by other methods. The fusion process is described in U.S. Pat. Nos. 3,338,696 and 3,682,609. Other suitable glass sheet forming methods include a float process, updraw and slot draw methods.

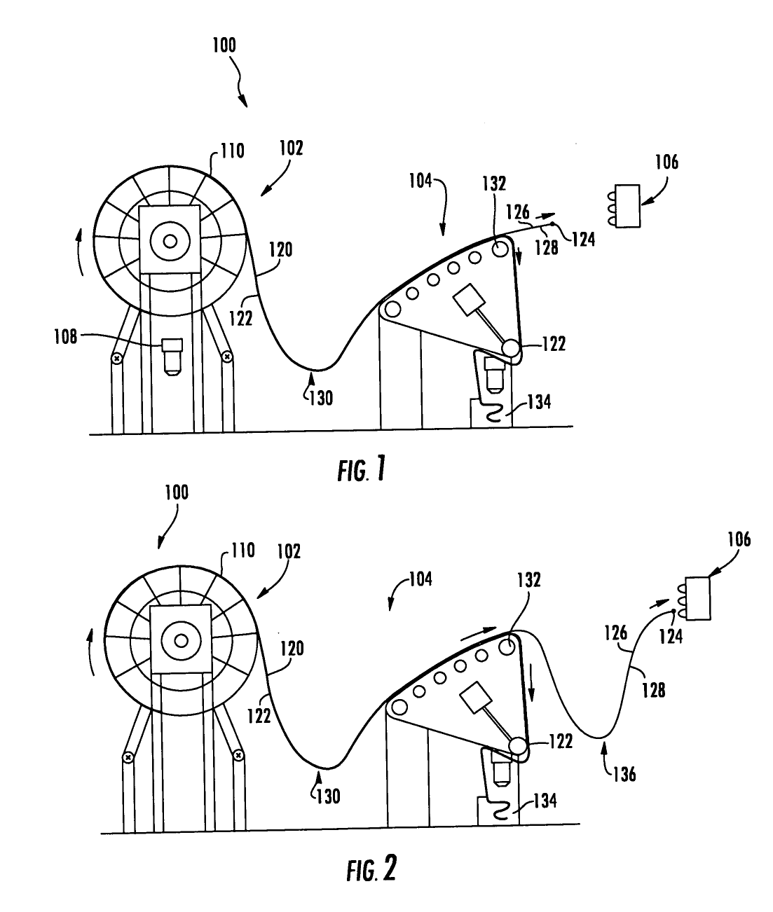

Referring now to FIG. 1, a schematic of a glass handling apparatus 100 is illustrated. In this embodiment, the glass handling apparatus 100 includes an unspooling apparatus 102, a conveyor device 104, and gantry of vacuum heads 106. The glass handling apparatus 100 allows a spool of glass 110 to be unspooled and processed. The spool of glass 110 includes a flexible glass 120 rolled together with an interleaf layer 122. The interleaf layer 122 may allow the glass handling apparatus 100 to unspool the flexible glass 120 without directly contacting the flexible glass 120 by providing a protective layer between components of the glass handling apparatus 100 and the flexible glass 120. This may reduce the risk of damaging or contaminating the flexible glass 120 by the glass handling apparatus 100. The spool of glass 110 may weigh several hundred pounds or more and may be difficult to unspool, which may also make it difficult to separate the flexible glass 120 or create a clean edge on the flexible glass 120 because of spool dynamics, such as vibrations propagating across the unwound glass or back and forth to and from the spool of glass 110.

The spool of glass 110 is introduced to the unspooling apparatus 102. Edge tape 124 may be present on the lateral edges of the flexible glass 120. The edge tape 124 may cover more or less than about 0.25 inch (6.35 mm) on both an upper 126 and lower 128 surface of the flexible glass 120 and may be highly adherent, so as to prevent the edge tape 124 from coming loose or dislodging during processing. The flexible glass 120 may be propelled along a conveyance path through the glass handling apparatus 100, or a glass processing apparatus, or any other downstream apparatus, by the gantry of vacuum heads 106, allowing the flexible glass 120 to remain free from mechanical contact during a portion of or all of the unspooling process. This may inhibit or reduce surface damage to the flexible glass 120 or otherwise prevent dust, debris, or other unwanted materials from contacting any surface of the flexible glass 120.

The unspooling apparatus 102 operates such that a motor 108 controls a rotational velocity of the spool of glass 110 and allows for controlled unspooling of the spool of glass 110. After unspooling, the flexible glass 120 and the interleaf layer 122 may be further transported until reaching the conveyor device 104. Further transporting may include guiding the flexible glass 120 through a series of nip rollers or air injection bars so as to achieve a certain orientation, for example. Between the unspooling apparatus 102 and the conveyor device 104, the flexible glass 120 may be allowed to form a “U” shaped portion 130 as shown in FIG. 1. This “U” shaped portion 130 may be maintained by measurement of the glass location and controlled unspooling of the flexible glass 120 by the unspooling apparatus 102. The “U” shaped portion 130 may free the unspooled flexible glass 120 from some or all of the dynamics of the spool of glass 110, such as vibrations propagating across the “U” shaped portion 130 and back and forth to and from the spool of glass 110.

The conveyor device 104 may be an air bearing conveyor device 104 such that the conveyor device does not make direct contact with the interleaf layer 122. Alternatively, because of the presence of the interleaf layer 122, the conveyor device 104 need not be an air bearing, as the interleaf layer 122 will protect the flexible glass 120 from contact with the conveyor device 104. The conveyor device may also include an isostatic bar apparatus 132 or other electrostatic device positioned on the conveyor device 104 that may remove the electrostatic charges or other ionic bonds between the flexible glass 120 and the interleaf layer 122. The isostatic bar apparatus 132 may include multiple isostatic bars, such as one that applies an electrostatic charge to the flexible glass 120 and another that applies an opposing electrostatic charge to the interleaf layer 122. The isostatic bar apparatus 132 may be used to remove the interleaf layer 122 from the flexible glass 120 by applying electrostatic charges of a polarity opposite that which the flexible glass 120 and interleaf layer 122 possess, or may otherwise neutralize any charges contained by the flexible glass 120 and the interleaf layer 122. Removal of any electrostatic charges may enable the interleaf layer 122 and flexible glass 120 to separate in a smooth fashion. Once separated from the flexible glass 120, the interleaf layer 122 can be spooled for reuse or discarded in a bin 134. After the interleaf layer 122 and the flexible glass 120 are separated, the flexible glass 120 may be floated downstream on air bearings to prevent direct contact with the flexible glass 120 to avoid damage or scratching.

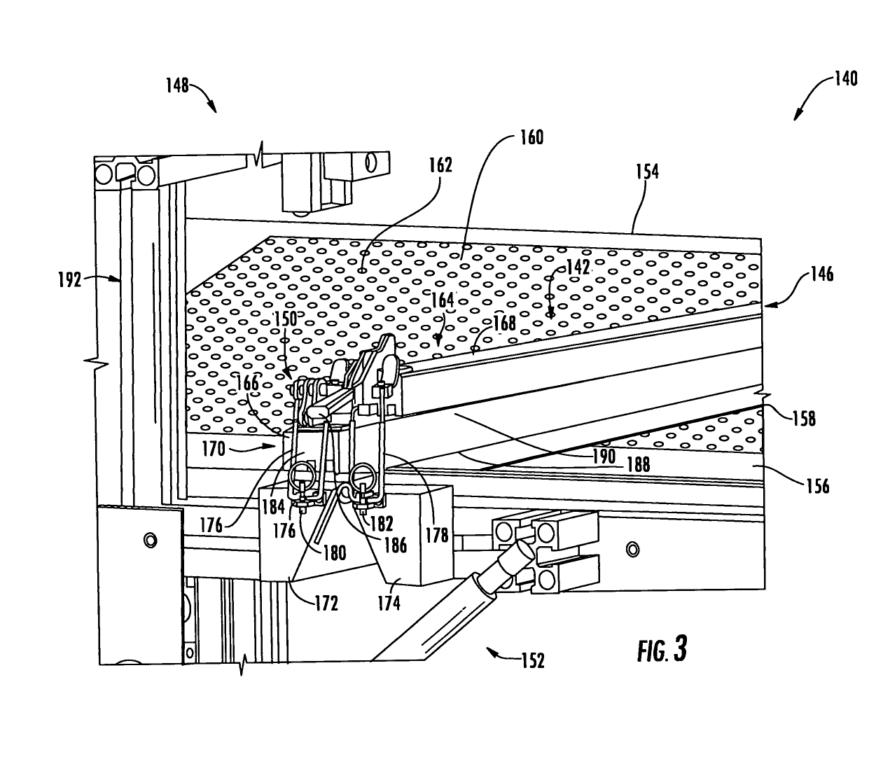

As shown in FIG. 2, a second “U” shaped portion 136 may be formed by the flexible glass 120. The second “U” shaped portion 136 may be positioned downstream from the conveyor device 104 and may further free the flexible glass 120 from the dynamics of the spool of glass 110. The second “U” shaped portion 136 may be beneficial when the glass handling apparatus 100 is connected to a downstream processing apparatus directly and/or when the spool of glass 110 is large. The two “U” shaped portions 130, 136 may allow movement of the flexible glass 120 with little dynamic change when further processing the flexible glass 120 (downstream of the “U” shaped portions 130, 136) and may minimize vibrations propagating across the “U” shaped portions 130, 136 and back and forth to and from the spool of glass 110. The unspooled flexible glass 120 may be further processed and directed to a break table, for example, where the flexible glass 120 may be separated into discrete glass sheets and/or spliced with a leader (or trailer) web, the process of which will be described in greater detail below.

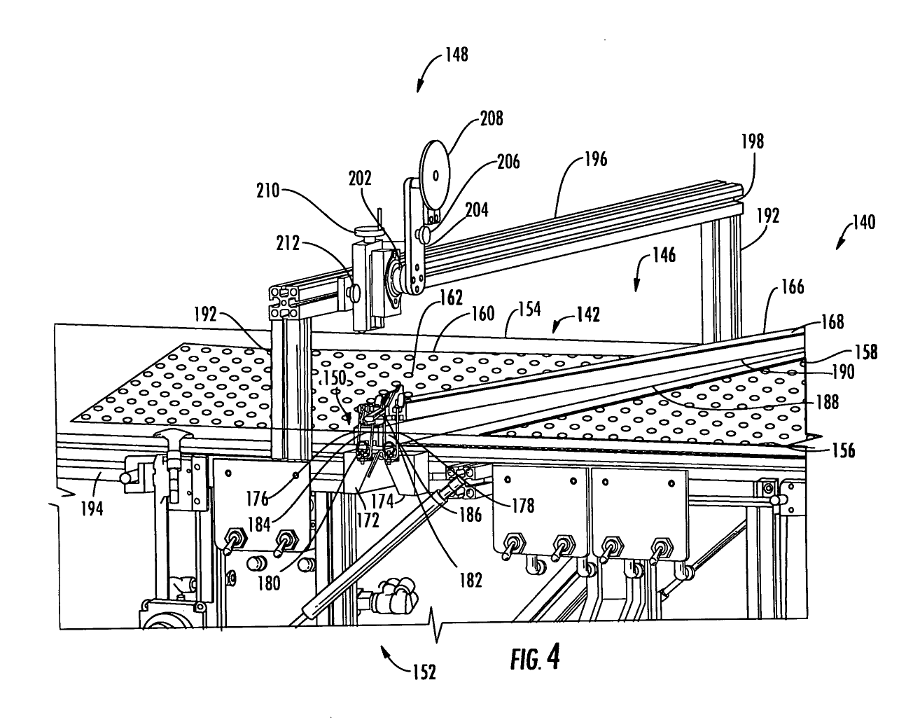

FIG. 3 illustrates one embodiment of a glass processing apparatus 140, which can be positioned downstream from the glass handling apparatus 100 (shown in FIGS. 1 and 2). The glass processing apparatus 140 may include a glass separation apparatus 142. The glass separation apparatus 142 includes a break table 146, a defect initiation assembly 148, a glass securing device 150 and an actuation mechanism 152. One embodiment of the break table 146, shown in FIG. 3, is oriented in a horizontal fashion and is part of the glass processing apparatus 140. The glass processing apparatus 140 may receive the flexible glass 120 from the glass handling apparatus 100, for example or from another source. The break table 146 has a first portion 154 and a second portion 156 separated by a hinging line 158. The hinging line 158 is a location that allows movement of the first portion 154 and the second portion 156, relative to each other, when one or more hinges on a bottom surface of the break table 146 are actuated by an actuation mechanism 152. The actuation mechanism 152 may be manual or automatic, and may be a lever, dial, or electronically controlled process, or the like.

The break table 146 has an upper surface 160 on which the flexible glass 120 may be positioned. The flexible glass 120 may be positioned such that the hinging line 158 on the break table 146 is near or coextends with an intended line of separation of the flexible glass 120. In some embodiments, the break table 146 may include air bearing and/or vacuum assemblies to minimize or eliminate physical contact with the processing equipment, and to secure the flexible glass 120, as discussed below.

The glass securing device 150 such as a nosing assembly 164 may be used to secure the flexible glass 120 to the break table 146. The nosing assembly 164 includes two nosing arms 166, 168 that extend across a width of the break table 146. The nosing arms 166, 168 may be hingedly connected on one side of the break table 146 that allow the nosing arms 166, 168 to rotate from a position almost perpendicular to the break table 146, or some other raised position as illustrated by nosing arm 168 in FIG. 3, down to a position almost parallel to and across the width of the break table 146, as illustrated by nosing arm 166 of FIG. 3. One nosing arm 166 is located on the first portion 154 side of the hinging line 158 and the other nosing arm 168 is located on the second portion 156 side of the hinging line 158. On the opposite end of the hinged connection of the nosing arms 166, 168 to the break table 146, the nosing arms 166, 168 may have locking mechanisms 170 that allow the nosing aims 166, 168 to be engaged with bases 172, 174 located on either side of the hinging line 158 and fixed to their respective first and second portions 154 and 156 of the break table 146. In FIG. 3, the nosing arm 166 is shown engaged with the base 172 located on the first portion 154 side of the hinging line 158 and the nosing arm 168 is shown disengaged with the base 174 located on the second portion side of the hinging line 158. When engaged with the base 172, 174, the nosing arms 166, 168 may be almost parallel to and apply pressure to the upper surface 160 of the break table 146. The locking mechanism 170 can be a “U”-lock, a latch mechanism, buckle, or other locking device. In FIG. 3, the locking mechanism 170 includes a “U”-lock 176, 178 that latches on to a hook 180, 182, and a lever 184, 186 that creates tension between the “U”-locks 176, 178 and the hooks 180, 182, thereby applying pressure when in a closed position, as the lever 184 is shown, or releases tension when in an open position, as the lever 186 is shown. A locking pin may also be used to secure the nosing arms 166, 168 to the bases 172, 174. The nosing arms 166, 168 may be rotated into position manually, or may be controlled automatically, such as by a motor or other linkage. Additionally, the nosing assembly 164 may be completely detachable from the glass processing apparatus 140 in another embodiment.

Attached underneath each of the nosing arms 166, 168 may be a nosing material 188, 190. In FIG. 3, the nosing material 188 is attached underneath the nosing arm 166 and the nosing material 190 is attached underneath the nosing arm 168. The nosing material 188, 190 may be composed of silicone rubber or another material that is known not to damage or scratch glass. The nosing material 188, 190 may be the only part of the nosing assembly 164 that makes contact with the upper surface of the flexible glass. The flexible glass is positioned so that the intended line of separation is near the hinging line 158 on the break table 146. If edge tape is used, the edge tape may be removed from the flexible glass 120 using shears or another removal device prior to applying the nosing assembly 164. The edge tape may also be removed automatically by a separate apparatus, or may be scored and removed along with the glass covered by the edge tape. Removal of the edge tape may assist the glass to lay flat on the break table 146. The upper surface 160 of the break table 146 may be air bearing and/or include a vacuum assembly, or may otherwise made of any material that will not damage the flexible glass, such as porous stainless steel, porous plastic, porous composite, porous polyethylene, or porous ceramic. The upper surface 160 may also be electrically conductive such that electrostatic charges are not retained on the upper surface 160 of the break table 146. In the embodiment shown in FIG. 3, the upper surface 160 of the break table 146 is air bearing and allows the flexible glass 120 to float above the table during positioning. This may reduce the need to physically or mechanically contact the flexible glass 120 prior to separating the flexible glass. Once the flexible glass 120 is moved into position on the break table 146, a vacuum assembly can be activated, as discussed below. The vacuum assembly pulls air towards the break table 146 through holes on the upper surface 160 of the break table 146 thereby securing the flexible glass in position on the upper surface 160 of the break table 146. When the glass is secured, the nosing arms 166, 168 are locked in position and the defect initiation assembly 148 is moved into position. In other embodiments, the defect initiation assembly 148 may be moved into position before the glass is secured, or the process may be automated.

In FIG. 4, the defect initiation assembly 148 is shown attached to the break table 146. The defect initiation assembly 148 may be attached to the break table 146 by one or more posts 192 located on both sides of the break table 146. The posts 192 are slidable transversely along rails 194 located on both sides of the break table 146 that may extend along the length of the break table 146. The rails 194 may be extended away from the break table 146 to allow a clearance for the nosing assembly 164. The posts 192 can be locked into position along the rails 194 by a locking mechanism. A default position for the posts 192 is such that the defect initiation assembly 148 aligns with the hinging line 158 of the break table 146. Between the two posts 192 is a rail 196 to which the defect initiation assembly 148 is attached. The defect initiation assembly 148 may slide laterally across the rail 196 from one post 192 to the other post 192 and can be locked into position by a locking mechanism 210. In the embodiment shown in FIG. 4, the defect initiation assembly 148 slides along a groove 198 located in a face of rail 196. The defect initiation assembly includes a lever arm 202, a swinging arm 204, a locking knob 206, and a vent forming device 208. When the flexible glass is positioned on the break table 146 and the nosing assembly 164 is in place, the posts 192 can be slid into position such that the defect initiation assembly 148, and more specifically, the vent forming device 208 can be positioned between the nosing arms 166, 168 and near the hinging line 158 of the break table 146. When the posts 192 are in position, the defect initiation assembly 148 can be unlocked by unscrewing the locking mechanism 210, which allows the defect initiation assembly 148 to slide freely along the rail 196. Locking knob 206 can then be pulled, which releases the swinging arm 204 from a locked position and allows the swinging arm 204 to rotate freely about the lever arm 202.

When the swinging arm 204 is rotated 180 degrees from an upright position, it may be automatically locked into place with locking knob 206. At this point, the vent forming device 208 will make contact with the flexible glass and initiate a defect (e.g., a partial vent only partially through a thickness of the flexible glass) in an upper surface of the glass. In some embodiments, a vent forming device may be used to create a defect initiation on the opposite (lower as shown in FIGS. 2 and 3) surface of the flexible glass. A damping mechanism may be included with the defect initiation assembly 148 to minimize dynamic impact on the glass and avoid creating a full vent that immediately propagates through the glass. The vent forming device 208 can then be pushed or pulled across the flexible glass 120 for a desired distance manually by using knob 212 or mechanically using an actuator to push or pull the defect initiation assembly 148 along the rail 196. This can create a score line (or partial vent) along the entire width or a portion of the width of the glass. Depending on the type of defect and edge quality desired, for example, a partial or full vent may be formed along a portion of the width or the entire width of the flexible glass, or a nick defect may be formed in one or both edges of the flexible glass. Specifically, a nick defect may be a partial or full vent formed at an edge across a small portion of the width of the flexible glass.

There are a variety of cutting and/or scoring mechanisms that may be employed depending, at least in part, on the type of defect initiation assembly 148 used, thickness of the flexible glass 120 and the type of cut and/or scoring desired. In some embodiments, a laser cutting mechanism, a mechanical scoring wheel, or razor knife as a vent forming device 208 may be used. When separating flexible glass having a thickness of, for example, less than or equal to 250 μm, laser cutting mechanisms may create a full vent rather than a partial vent and immediately propagate through the entire thickness of the flexible glass. As used herein the term “vent” is meant to cover a vent extending partially through the thickness of the glass, as well as a vent extending through the thickness of the glass, as such may advantageously be used in different situations and for different desired results. A laser cutting mechanism, that produces a full body separation, may produce high quality and strong edges for glass thicknesses less than or equal to 250 μm. In this embodiment, although a full vent creates two distinct portions of flexible glass, the glass separation apparatus 142 may assist is separating the two distinct portions of flexible glass and prevent newly created edges from contacting one another, thus preserving edge strength and maintaining edge quality. In other embodiments, it may be desirable to create only a partial vent through only a portion of the thickness of the flexible glass. Regardless of the type of vent (full or partial), the vent may extend across the entire width of the flexible glass or across only a portion of the width of the flexible glass. In some embodiments, only a nick defect may be created (full or partial through the thickness of the flexible glass) on one or both lateral edges of the flexible glass 120, and the vent is propagated by the rotation of the break table portions that also flexes the glass.

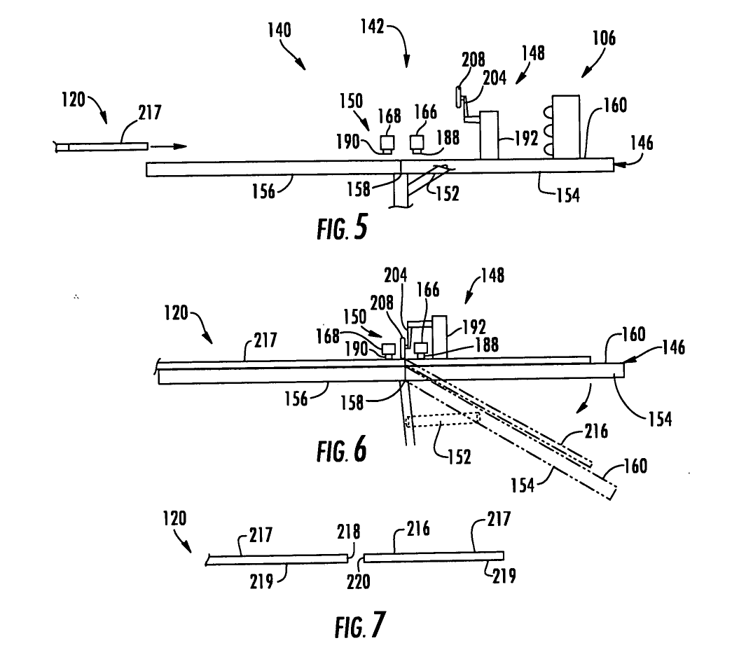

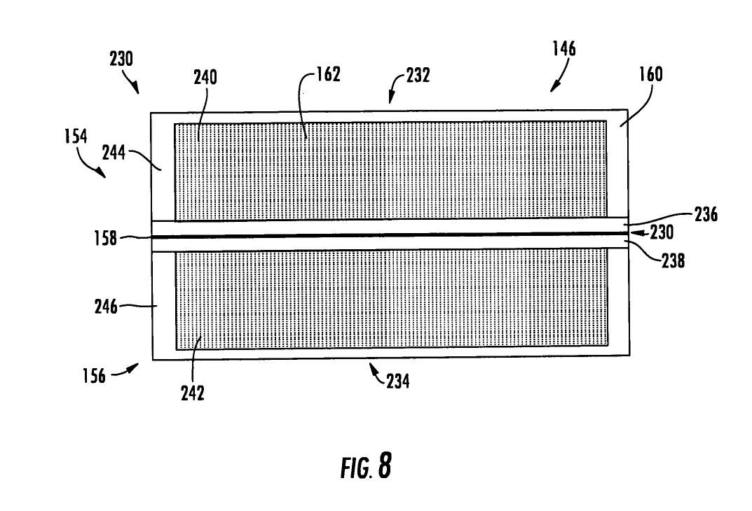

FIGS. 5-7 illustrate an embodiment of the flexible glass 120 being positioned on and sectioned by the glass separation apparatus 142. In FIG. 5, the flexible glass 120 is delivered to the break table 146 by the gantry of vacuum heads 106. The flexible glass 120 floats on top of the upper surface 160 of the break table 146 due to the air bearing capability (with perforations 162 shown in FIG. 3) of the break table 146. In FIG. 6, when the flexible glass 120 is in the desired position, the vacuum assembly is enabled on the break table 146 and the flexible glass 120 is secured in position, with the intended line of separation between the two nosing arms 166, 168 and near the hinging line 158. The intended line of separation may be within about 0.5 inch (12.5 mm) of the hinging line 158 or less. The nosing arms 166, 168 are rotated down almost parallel to the upper surface 160 of the break table 146 such that the nosing materials 188, 190 are in contact with an upper surface 217 of the flexible glass 120 and locked into position to further secure the flexible glass 120 to the upper surface 160 of the break table 146. As shown in FIG. 6, the posts 192 are positioned such that the defect initiation assembly 148 is aligned near the hinging line 158 of the break table 146. The swinging arm 204 is rotated 180 degrees from an upright position so that the vent forming device 208 makes contact with the upper surface 217 of the glass. The defect initiation assembly 148 may then be moved along the rail 196 so that a partial vent can be created in the upper surface 217 of the flexible glass 120. When a partial vent has been formed in the upper surface 217 of the flexible glass 120, the swinging arm 204 may be moved into an upright position. If the flexible glass 120 is cut by a laser cutting mechanism, then the bending mechanism may allow for removal of the two portions of flexible glass, avoiding contact between the edges of the two portions of flexible glass and maintaining high edge strength.

In FIG. 6, the actuation mechanism 152 is actuated that may allow the first portion 154 of the break table 146 to rotate around the hinging line 158 with respect to the second portion 156 of the break table 146, or vice versa. This rotation creates a bending moment and may cause the defect initiation, partial vent, or other defect created in the upper surface 217 of the flexible glass 120 by the vent forming device 208 to propagate through the thickness of the flexible glass 120. The rotation may be about 15 degrees or more, with respect to the initial position of the break table 146, and can vary to as many or as few degrees as required to create a sufficient bending moment and propagate the defect through the glass. Because the flexible glass 120 may be about 0.3 millimeter thick or less, the glass may be flexible and bend when the break table 146 is actuated, which may make separating the flexible glass 120 difficult. The nosing assembly 164 and/or vacuum assemblies may help increase the bending of the flexible glass 120 by securing the flexible glass 120 to the break table 146, thereby increasing the propensity for the flexible glass 120 to follow the path of the break table 146. The bending moment and pressure applied by either the first or second nosing arms 166, 168 creates a discrete length of flexible glass 216 that is removed from the flexible glass 120, and may create the length of flexible glass 216 of high edge quality and a specific desired size. In FIG. 7, the length of flexible glass 216 is shown separated from the flexible glass 120, along with newly created edges 218, 220. Because the defect on the upper surface 217 of the flexible glass 120 is propagated through the flexible glass 120 by a bending moment, the quality of the edges 218, 220 may be cleaner, stronger and more exact, with minimal surface damage, than the edge quality of glass cut by a different process. Glass cut by other processes may weaken the edges of the glass and may initiate microcracks along the upper 217 and lower 219 surfaces of the flexible glass itself. In other embodiments, an automatic pneumatic or hydraulic lever can be used to actuate the rotation of one portion of the break table 146.

FIG. 8 is a close-up schematic drawing of the upper surface 160 of the break table 146. In this embodiment, the break table 146 includes a vacuum assembly 230, with a first vacuum assembly 232 that corresponds to the first portion 154 of the break table 146 and a second vacuum assembly 234 that corresponds to the second portion 156 of the break table 146. The hinging line 158 separates the first vacuum assembly 232 from the second vacuum assembly 234. Two lips 236, 238 on both sides of the hinging line 158 may contain one or more grooves for the vent forming device 208 to travel along, or for a razor knife to travel along in order to create a straight edge for a leader web during splicing, as discussed below. The grooves may assist the vent forming device 208 in ensuring a straight partial vent is created in the upper surface 217 of the flexible glass 120. Two faceplates 240, 242 are positioned flush on a surface of the break table 146 on top of the vacuum assemblies 232, 234. The faceplates 240, 242 have a predetermined amount, size and location of holes for air to travel through. The holes allow the vacuum assemblies 232, 234 to pull or push air through the faceplates 240, 242. The hinging line 158 may create a gap, such as about a 0.062 inch (1.6 mm) gap, that creates separation between the first 154 and second 156 portions of the break table 146, creating space for the lips 236, 238. Other gap sizes may be used that are greater or less than 0.062 inch (1.6 mm). The faceplates 240, 242 may not cover the entire upper surface 160 of the break table 146. Instead, the faceplates 240, 242 may be limited to certain regions on the upper surface 160, and leave a surrounding edge of the upper surface 160 exposed, such as edges 244, 246 shown in FIG. 8.

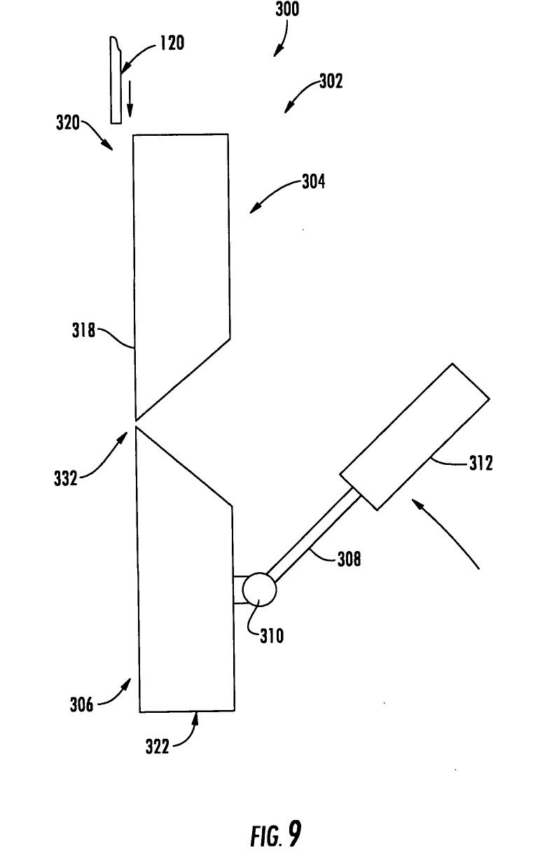

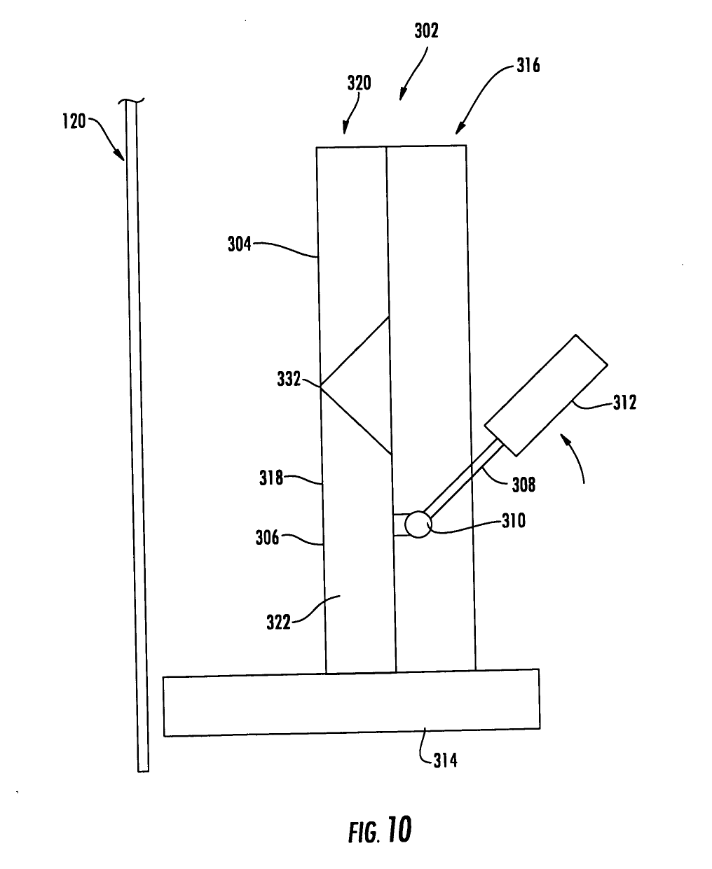

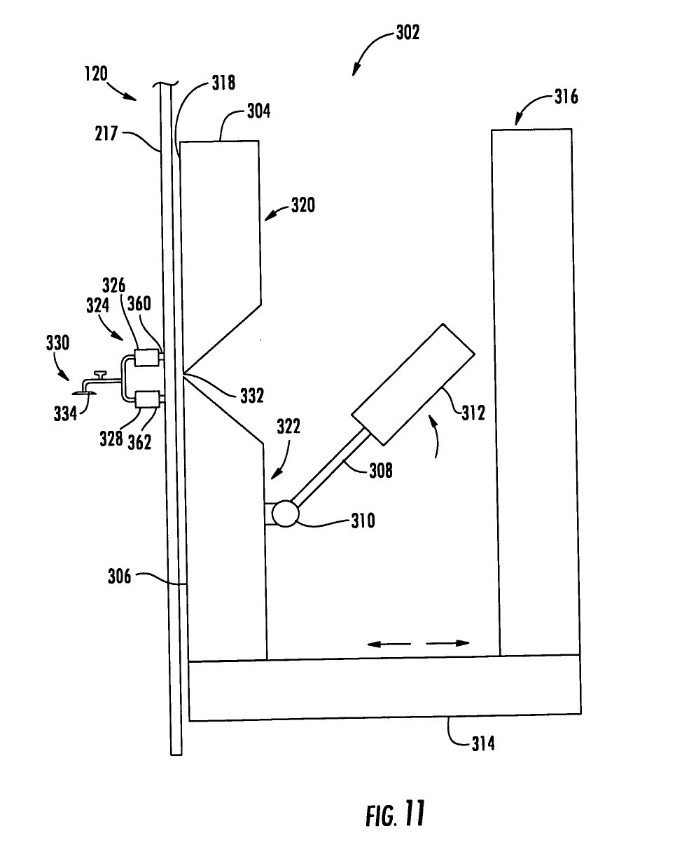

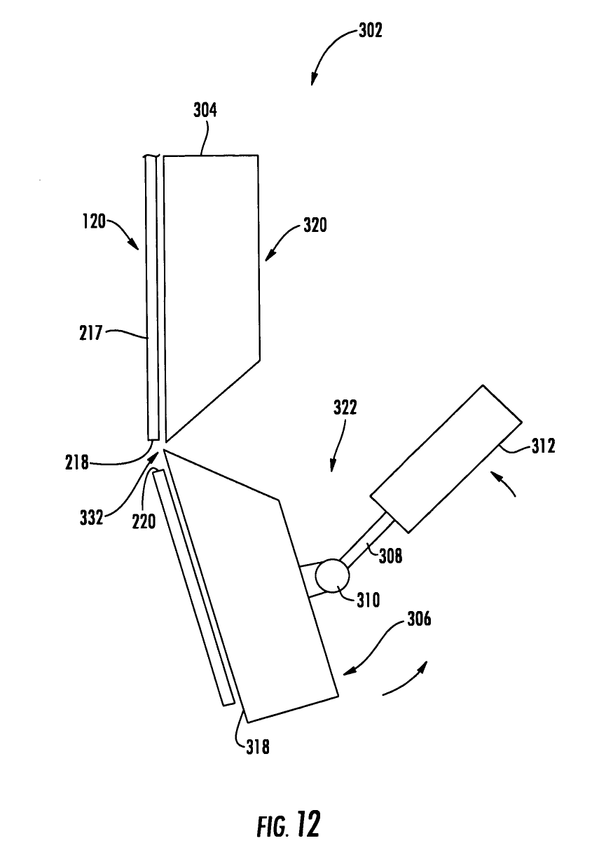

FIGS. 9-12 show another embodiment of a glass processing apparatus 300 that includes many similar features to the glass processing apparatus 200 including a break table 302 configured in a vertical orientation. In this embodiment, as shown in FIG. 9, the flexible glass 120 is fed to the break table 302 from an upstream source in a vertical fashion. The first portion 304 of the break table 302 is located above the second portion 306. A lever arm 308 is attached to the second portion 306 of the break table 302 at a connection 310. A handle 312 allows the second portion 306 of the break table 302 to be rotated away from the flexible glass 120 and towards the first portion 304 of the break table. In this embodiment, a defect initiation assembly 330 with a vent forming device 334 may be manually attached to the break table 302, and then removed after the defect initiation or score or partial vent is created in the upper surface 217 of the flexible glass 120, as shown in FIG. 11. When oriented vertically, the break table 302 can slide along rail 314 towards and away from the flexible glass 120. In FIG. 10, the break table 302 is shown in a position away from the flexible glass 120, touching backstop 316. This may allow for easier positioning of the flexible glass 120 prior to separation. When the flexible glass 120 is in position, the break table 302 can be slid along rail 314 towards the flexible glass 120 so that the flexible glass 120 is within vacuum range of the outer surface 318 of the break table 302, as shown in FIG. 11. When the break table 302 is in position, vacuum assemblies 320, 322, as discussed above, may be activated and nosing assembly 324 may be positioned to secure the flexible glass 120 to the outer surface 318 of the break table 302 and nosing arms 326, 328 with nosing material 360, 362 may be clamped to the break table 302. In this embodiment, the nosing arms 326, 328 may latch to both sides of the break table 302, rather than being fixed to one end with a hinge.

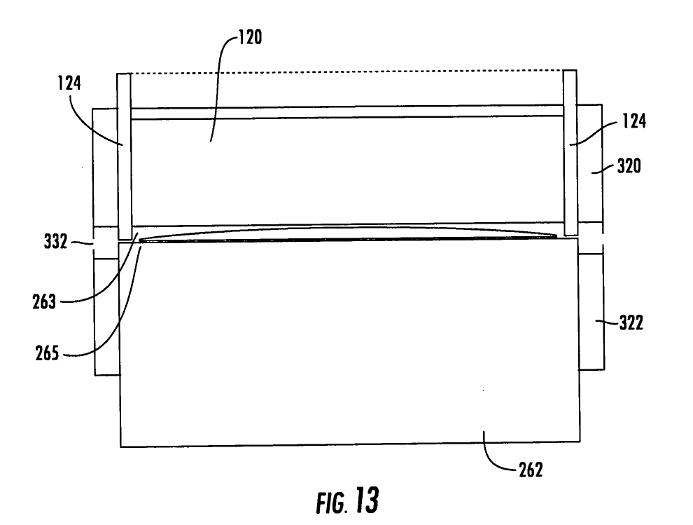

After the flexible glass 120 is secure, the defect initiation assembly 330 may be manually positioned so that a partial or full vent will be formed in the flexible glass 120 along an intended line of separation near hinging line 332 by vent forming device 334. In FIG. 12, when the partial or full vent is created in the upper surface 217 of the flexible glass 120, the defect initiation assembly 330 is removed, and handle 312 is actuated so that the second portion 306 of the break table 302 rotates away from the flexible glass 120 and towards the first portion 304 of the break table 302, or vice versa. This creates a bending moment that may cause the partial or full vent or other surface defect created by the defect initiation assembly 330 to propagate through the glass, thereby separating a discrete length of flexible glass 216 from the flexible glass 120. The same edges 218, 220 as above are applicable to the vertical orientation of the break table 146.

FIG. 13 illustrates a leader web 262 being spliced (e.g., using an adhesive) to the flexible glass 120. In some embodiments, a user may wish to remove the length of flexible glass 216 from the flexible glass 120 to form a clean edge, and then splice the leader web 262 to the flexible glass 120 to make it easier to ship or use the glass with manufacturing apparatuses. The leader web 262 may be any suitable material, such as various plastic sheet materials. The flexible glass 120 may be processed by high-speed equipment or roll-to-roll spooling, and the leader web 262 may help in threading the processing equipment. In the embodiment shown in FIG. 13, the break table is shown behind the flexible glass 120 after it has been separated from a length of flexible glass 216. The leader web 262 may be positioned underneath or over the flexible glass 120 so that an edge 265 of the leader web 262 is underneath or on top of the flexible glass 120. Similarly, an edge 263 of the flexible glass 120 may be positioned underneath or over the leader w4eb 262. The flexible glass 120 is held in place either by a nosing or by the vacuum assembly 320 of the first portion 304 of the break table 302, or both, and may then be manually spliced using splice tape or another material to join the flexible glass 120 and the leader web 262 together. For example, when the edge 265 of the leader web 262 is placed on top of the flexible glass 120, splice tape may bridge across edge 265 to connect the leader web 262 to the top of the flexible glass 120. Similarly, for example, when the edge 263 of the flexible glass 120 is placed on top of the leader web 262, splice tape may bridge across the edge 263 to connect the flexible glass to the top of the leader web 262. Alternatively, for example, the edges 263, 265 of the leader and flexible glass may be brought in close proximity to one another, yet wherein one is not atop the other, so as to form a butt splice with tape bridging across both edges 263, 265 and on either both top or both bottom surfaces of the flexible glass 120 and leader web 262. Other types of splices known in the art may also be used to connect the leader web 262 with the flexible glass 120. The leader web 262 may then be spooled and may become the trailing (or leading) edge on a new spool for a customer. Because part of this embodiment may be automated, splicing time may be reduced as less time is required to position the glass at the hinging line 332 and less splice tape may be used since only one side of the flexible glass 120 and leader web 262 is spliced.

Predictable severing of glass and high quality, strong edges produce samples that may benefit customers by providing glass samples of specific sizes. By using a process that is capable of sectioning a length of flexible glass 216 from a flexible glass 120 in which the edges of the glass may be thicker than the center, a less fragmented length of flexible glass 216 can be formed with less glass chipping. Additionally, the methods and apparatuses described herein can be manually or automatically used to provide as little as ten discrete glass sheets, or scaled up to produce over ten thousand discrete glass sheets, or more. This may accelerate market penetration for new glass products by allowing samples to be created in specific sizes, or rolls of glass to be spooled with a leader allowing easier use of the glass with a customer's manufacturing apparatus. A customer may process the glass at high speed via roll-to-roll spooling, where the glass is dispensed from one roll, processed, and spooled onto a second roll. Non-contact conveyance and steering, as disclosed herein, may minimize flaws, damage, surface scratches, diminished clarity, or contamination.

Many modifications and other embodiments of the embodiments set forth herein will come to mind to one skilled in the art to which the embodiments pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims. It is intended that the embodiments cover the modifications and variations of the embodiments provided they come within the scope of the appended claims and their equivalents. Although specific terms are employed herein, they are used in a generic and descriptive sense only and not for purposes of limitation.

1. A glass processing apparatus comprising:
a vent forming device configured to provide a vent in a length of flexible glass along an intended line of separation;
a break table comprising a first portion and a second portion, at least one of the first and second portions of the break table configured to rotate with respect to each other along a hinging line; and
a glass securing device configured to secure the length of flexible glass to the first and second portions of the break table for separating the length of flexible glass into multiple lengths of flexible glass along the intended line of separation.

2. The glass processing apparatus of claim 1, wherein the glass securing device includes a first nosing arm for securing the length of flexible glass to the first portion of the break table and a second nosing arm for securing the length of flexible glass to the second portion of the break table.

3. The glass processing apparatus of claim 2, wherein the first nosing arm is spaced from the second nosing arm, the hinging line located between the first and second nosing arms.

4. The glass processing apparatus of claim 3, wherein the vent forming device moves between the first nosing and the second nosing to provide the vent in the surface of the length of flexible glass along the intended line of separation.

5. The glass processing apparatus of claims 1-4, wherein the break table comprises a vacuum assembly to hold the flexible glass during formation of the vent.

6. The glass processing apparatus of claim 1, wherein the break table includes an air bearing assembly configured for positioning the flexible glass on the break table.

7. A method of separating lengths of flexible glass comprising:
feeding a length of flexible glass to a break table;
positioning the length of flexible glass on the break table;
applying a force to the length of flexible glass to secure the length of flexible glass to the break table;
scoring the length of flexible glass to form a vent along an intended line of separation using a vent forming device;
rotating a first portion of the break table with respect to a second portion of the break table about a hinging line using an actuation mechanism;
propagating the vent through the thickness of the length of flexible glass; and
separating the length of flexible glass into two portions.

8. The method of claim 7 further comprising applying a force to the length of flexible glass to secure the length of flexible glass to the break table by a first nosing arm located at the first portion of the break table and a second nosing arm located at the second portion of the break table.

9. The method of claim 8, wherein the first nosing arm is spaced from the second nosing arm, the hinging line located between the first and second nosing arms.

10. The method of claim 9, wherein the step of scoring the length of flexible glass to form the vent includes positioning a vent forming device between the first nosing and the second nosing.

11. The method of claim 7 further comprising applying a force to the length of flexible glass to secure the length of flexible glass to the break table by a vacuum assembly.
